(19) United States
(12) Patent Application Publication
(10) Pub. No.: US 2007/0217396 A1
(43) Pub. Date: Sep. 20, 2007

(54) Method and apparatus for making VoIP connection through network

(75) Inventor: Chen-wei Su, Taipei (TW)

Correspondence Address: MERCHANT & GOULD PC, P.O. BOX 2903, MINNEAPOLIS, MN, 55402-0903, US

(73) Assignee: AIBELIVE Co., Ltd.

(21) Appl. No.: 11/374,036

(22) Filed: Mar. 14, 2006

(51) Int. Cl. H04L 12/66

(52) U.S. Cl. 370/352

(57) ABSTRACT

A method for establishing a voice connection through a network is provided. The method comprises the steps of receiving a voice information; analyzing the voice information and generating a recognized result; and establishing the voice connection through the network according to the recognized result. Apparatus and machine-readable medium which can execute a method of the invention are also provided.

### FIELD OF THE INVENTION

The invention relates to a method, an apparatus and a machine-readable medium for establishing a voice connection, more particularly to a method, an apparatus and a machine-readable medium for establishing a voice connection through a network.

### BACKGROUND OF THE INVENTION

In the recent years, Voice over Internet Protocol (VoIP) is a popular technique allowing people to make phone calls over the Internet. VoIP converts the voice signal from a telephone into a digital signal that travels over the Internet then converts it back at the other end so that a user can speak to anyone with a regular phone. When placing a VoIP call using a phone with an adapter, the user will hear a dial tone and dial just as you always have. VoIP may also allow people to make a phone call from a computer using a wired telephone device.

For establishing a VoIP connection between computers, there are a lot of freeware, such as Skype, MSN, Yahoo messager and Google talk, provided. In general, such Internet telephony software provides users with a friendly user's interface capable of inputting information, e.g., name, email address, telephone number, of friends. When the user would like to make a phone call through a network, the user has to select a friend on the list of the user's interface and then click a specific icon to establish the VoIP connection with the friend. The operation of the Internet telephony software is controlled by a general I/O device, e.g., a mouse of a keyboard. Such operation is not convenient for the user. Therefore, there is a need for providing a more convenient way to establish the voice connection through the network.

### SUMMARY OF THE INVENTION

The present invention provides a method, an apparatus and a machine-readable medium for establishing a voice connection through a network, whereby the operation for establishing a voice connection through a network is more convenient and friendly for a user.

According to an embodiment of the present invention, a method for establishing a voice connection through a network is disclosed. The method comprises: receiving a voice information; analyzing the voice information and generating a recognized result; and establishing the voice connection through the network according to the recognized result.

According to another embodiment of the present invention, a method for receiving a voice call through a network is disclosed. The method comprises: identifying the received voice call through the network and providing a voice information indicating the calling party; getting through the voice call upon a user's command or providing a voice message asking the calling party to leave message according to the user's setting.

According to still another embodiment of the present invention, a machine-readable medium embodied thereon a program configured to cause a machine to establish a voice connection through a network is disclosed. The program comprises code segments for causing the machine to: receive a voice information; analyze the voice information and generate a recognized result; and establish the voice connection through the network according to the recognized result.

According to yet another embodiment of the present invention, an apparatus for establishing a voice connection through a network is disclosed. The apparatus comprises: a voice recognition unit for analyzing a received first voice information and generating a recognized result; and a control unit, coupled to the voice recognition unit, for establishing the voice connection through the network according to the recognized result.

Since the operation of establishing a voice connection through a network is controlled by a user's voice command without utilizing a mouse or keyboard, it is more convenient and friendly for a user.

The other objects and achievements of the present invention will become apparent through the description of the present invention and the claims, with reference to the accompanying drawings, and the present invention will be generally understood.

### BRIEF DESCRIPTION OF THE DRAWING

FIG. 1 is a block diagram of an apparatus for making a voice connection according to an embodiment of the present invention.

FIG. 2 is a flow chart of a dial-out procedure of the apparatus according to an embodiment of the present invention.

FIG. 3 is flow chart of a call-in procedure of the apparatus according to an embodiment of the present invention.

FIG. 4 is a block diagram of an apparatus for making a voice connection according to another embodiment of the present invention.

FIG. 5 is a flow chart of the dial-out procedure of the apparatus according to another embodiment of the present invention.

FIG. 6 is a flow chart of the call-in procedure of the apparatus according to another embodiment of the present invention.

In all of the above accompanying drawings, the same referential numerals are used to indicate the same, similar, or corresponding characteristics or functions.

### DETAILED DESCRIPTION OF THE INVENTION

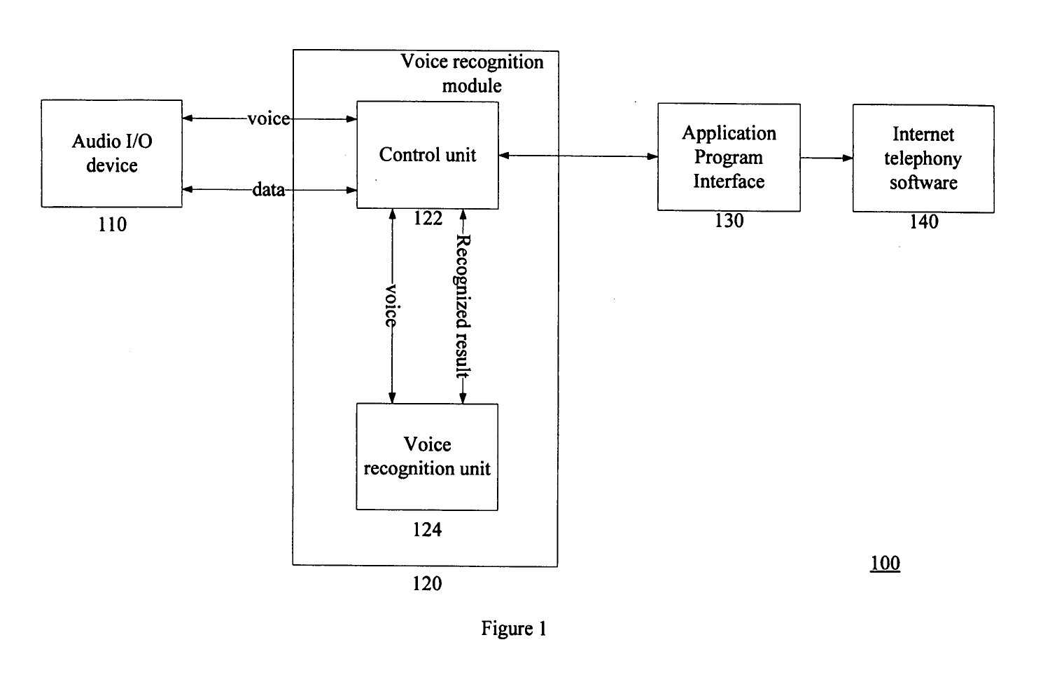

Please refer to FIG. 1 which is a block diagram of an apparatus, such as a voice recognition module 120, for making a voice connection, such as a VoIP connection, through a network, such as the Internet, according to an embodiment of the present invention. The voice recognition module 120 comprises a voice recognition unit 124 for analyzing a received first voice information and generating a recognized result; and a control unit 122, coupled to the voice recognition unit 124, for establishing the voice connection through the network according to the recognized result.

According to another embodiment of the present invention, the apparatus for establishing a voice connection further comprises at least one of audio I/O device 110, Application Program Interface (API) 130, and network telephony software 140. In another embodiment of the present invention, the network telephony software 140 is one of the Internet telephony software, such as Skype. Therefore, we take Skype as an example in the following paragraphs. It should be noted that the network telephony software 140 could be MSN, Google Talk, or other VoIP software according to the present invention. In the present embodiment, the audio I/O device 110 could be a wired telephone device or a microphone electrically coupled to the voice recognition module 120. The audio I/O device 110 provides voice information to the voice recognition module 120 in which voice recognition unit 124 is utilized for analyzing the received voice information and then generating a recognized result accordingly. The control unit 122 is further utilized for propagating voice information and controlling the operation of the network telephony software 140 according to the recognized result. In another embodiment, the control unit establishes a second voice connection through another IP or phone number (such as mobile phone number) when the voice connection through the network cannot be established. Additionally, the API 130 may be an open source announced by the development team of Skype allowing other application program access the services of Skype.

According to an embodiment of the present invention, a method for establishing a voice connection through a network comprises the steps of receiving a voice information; analyzing the voice information and generating a recognized result; and establishing the voice connection through the network according to the recognized result.

According to another embodiment of the present invention, the voice connection is a single voice connection (one-to-one voice connection) or a group of voice connection (one-to-multiple voice connection) and is established by one of network telephony software comprising Skype, MSN, Google Talk, and VoIP software.

According to another embodiment of the present invention, a method for establishing a voice connection through a network further comprises the step of providing a first default voice message when receiving a connection signal from an audio I/O device. According to another embodiment of the present invention, a method for establishing a voice connection through a network further comprises the step of determining at least one IP or phone number corresponding to the voice information according to the recognized result.

According to another embodiment of the present invention, a method for establishing a voice connection through a network further comprises the step of establishing a second voice connection, automatically or according to a user's selection, through another IP or phone number when the voice connection through the network cannot be established.

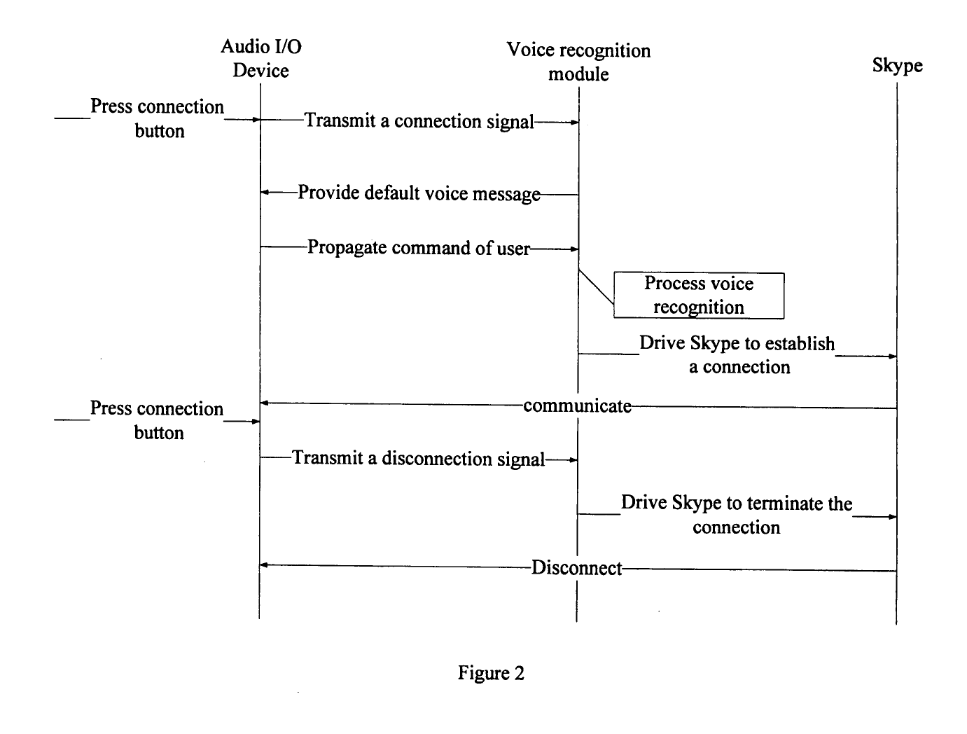

Referring to FIG. 2, FIG. 2 is a flow chart of a dial-out procedure of the apparatus according to an embodiment of the present invention. If the audio I/O device 110 receives an voice information asking to establish a voice connection to a specific person (or a group of specific persons) from a user, the audio I/O device 110 transmits the voice information to the control unit 122, and the control unit 122 passes the voice information to the voice recognition unit 124 for analyzing the meaning of the voice information and then determining at least one of the IP(s) or phone number(s) of the specific person(s) according to the recognized result and a phone book of the network telephony software 140 (e.g., Skype). For example, if the voice information means “call Bob,” the control unit 122 inquires the phone book of Skype, and finds out at least one IP or phone number of Bob for establishing a voice connection (such as VoIP connection) through the API 130. If the connection is established successfully, the control unit 122 is in charge of propagating voice information between the audio I/O device 110 and the network telephony software 140. However, if the connection cannot be established, the control unit 122 is capable of drive the network telephony software 140 to dial a phone number of the specific person by performing a service, such as Skype-out, automatically or according to a user's selection. However, if there is no phone number of the specific person recorded or the specific person is not available, the control unit 124 may drives the audio I/O device 110 to play a voice message replying the user that the connection cannot be established.

For saving power or meeting certain design considerations, the user can press a connection button on the audio I/O device 110 before saying the command in the present embedment. Once the connection button is pressed, the audio I/O device 110 transmits a connection signal to the control unit 122 and then the control unit 122 transmits a default voice message to the audio I/O device 110 for asking user's voice commands. Afterward, the control unit 122 is ready to receive the voice information or command from the audio I/O device 110 and drives Skype to establish a voice connection. When the user would like to disconnect the connection, the user may press the connection button of the audio I/O device 110 again so as to transmit a disconnection signal to the voice recognition module 120 to drive the Skype to terminate the connection.

According to an embodiment of the present invention, a method for receiving a voice call through a network comprises the steps of identifying the received voice call through the network and providing a voice information indicating the calling party; getting through the voice call upon a user's command or providing a voice message asking the calling party to leave voice message according to the user's setting. According to another embodiment of the present invention, the method further comprises the step of playing at least one left voice message upon the user's request.

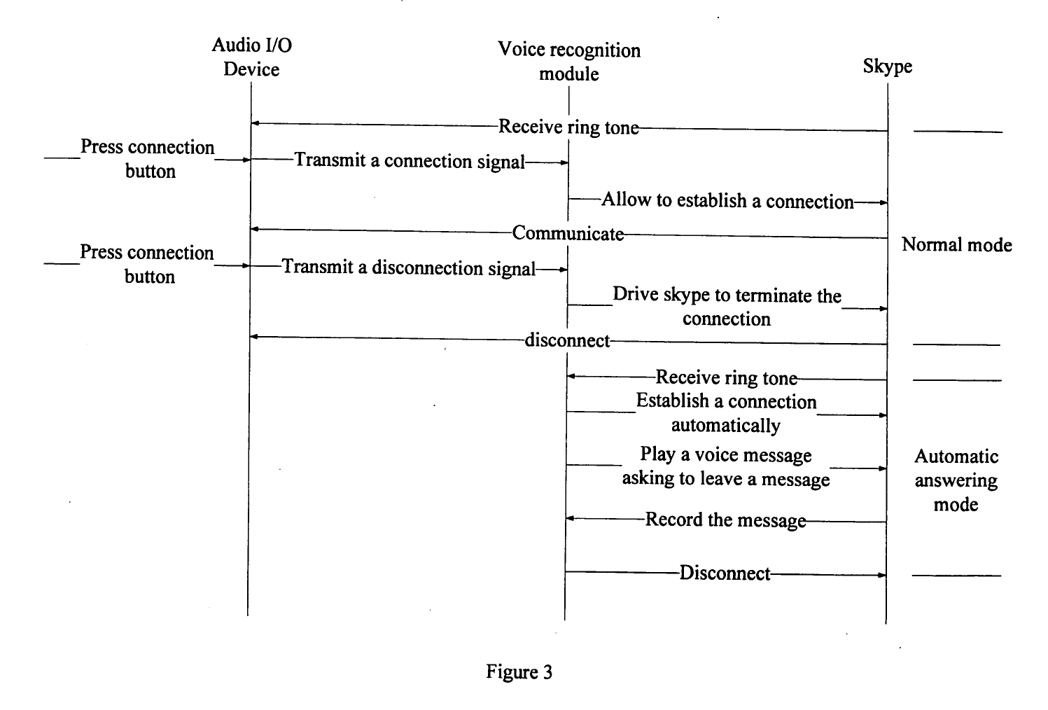

FIG. 3 is flow chart of a call-in procedure of the apparatus according to an embodiment of the present invention. If the computer or phone device on the other side would like to establish a voice connection, the control unit 122 may identify the received voice connection according to the phone book of Skype and then provide the Audio I/O device 110 with a voice information indicating the calling party. If the calling party cannot be identified, the control unit 122 may directly provide the audio I/O device 110 with the ring tone. After the user presses the connection button on the audio I/O device 110, the voice connection is established and the voice information of the user or the calling party is propagated through the audio I/O device 110, the control unit 122, API 130 and the network telephony software 140 and the computer or phone device of the calling party. In other words, the user is capable of talking to the calling party after pressing the button. If the user is busy or the user would not like to answer the predetermined calling party, the control unit 122 may provide a voice message asking the calling party to leave voice message according to the user's setting. The message recorded by the control unit 122 is then played upon the user's request. When the user would like to hear the recorded message, the control unit 122 would play voice massage asking the user to select, play, repeat or delete the recorded messages.

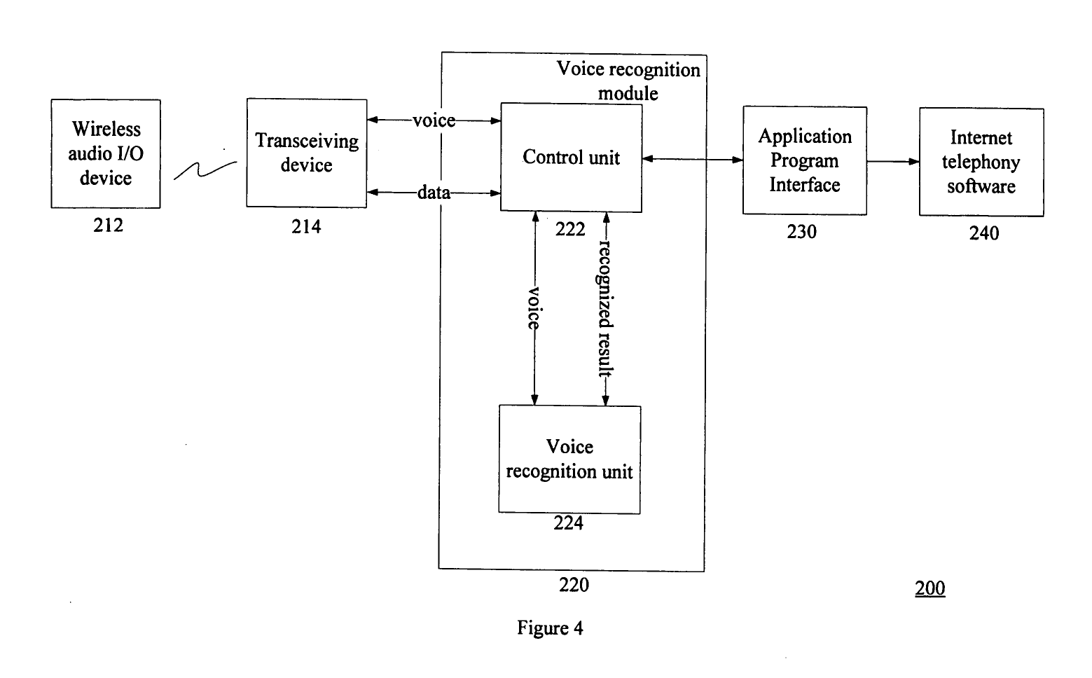

Please refer to FIG. 4. FIG. 4 is a block diagram of the apparatus 200 for making a voice connection according to another embodiment of the present invention. The apparatus 200 comprises a wireless audio I/O device 212, a transceiving device 214, a voice recognition module 220, an Application Program Interface (API) 230, and a network telephony software 240, wherein the voice recognition module 220 includes a control unit 222 and a voice recognition unit 224. In the present embodiment, the wireless audio I/O device 212 may be a bluetooth handset for receiving or playing a voice information, and the transceiving device 214 may be a bluetooth dongle plugged in the USB port of the user's computer for propagating data and voice information between the wireless audio I/O device 212 and the control unit 222. In the present embodiment, if the user would like to make a voice connection through the network, the user just needs to press the connection button on the bluetooth handset and says the command, then the voice information carrying the command is passed to the control unit 222 through the transceiving device 214.

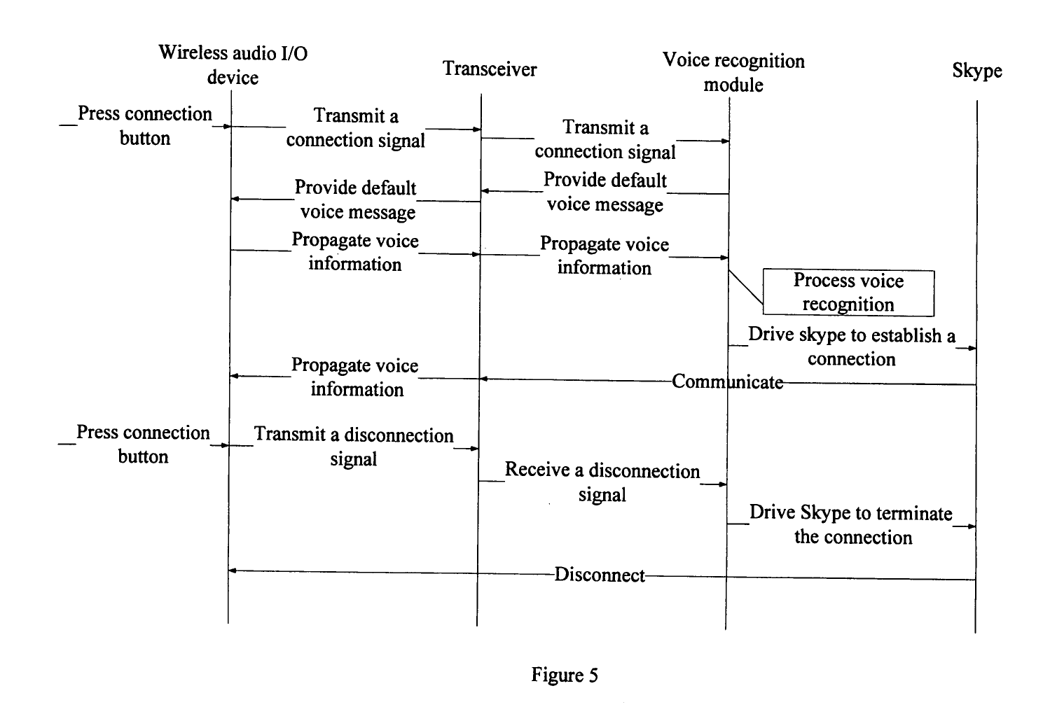

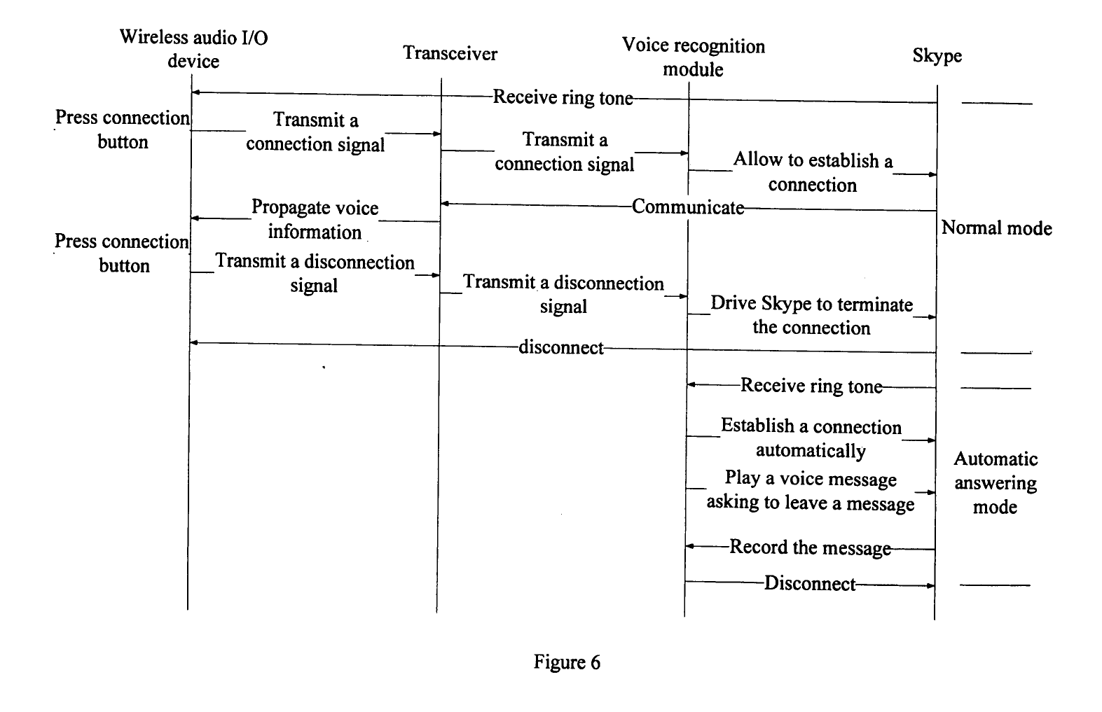

Since the functions of the voice recognition module 220, the Application Program Interface (API) 230, and the network telephony software 240 are the same as those of the devices having the same name depicted in FIG. 1, the functions thereof is not redundantly stated. FIG. 5 and FIG. 6 are flow charts of the dial-out procedure and the call-in procedure of the apparatus 200. They are also similar to those of FIG. 2 and FIG. 3, and are thus not redundantly stated.

It should be noted that the voice recognition modules 120 and 220 may be implemented by a circuit or a program comprising code segments. If the voice recognition module 120 or 220 is implemented by a circuit, it may be embedded in the transceiving device 214 or an interface card plugged in the computer. If the voice recognition module 120 or 220 is implemented by a program, it can be stored on a machine-readable medium and executed by a computer, a PDA, or other machines. Examples of a machine-readable medium include recordable-type medium such as a floppy disc, a hard disc drive, a RAM and CD-ROMs and transmission-type medium such as digital and analog communication links. Similarly, the above methods of the present invention also can be implemented by a program stored on a machine-readable medium.

According to the present invention, the operation for establishing a voice connection through a network is more convenient and friendly for a user.

Although the technical contents and features of the present invention have been illustrated above, variations and modifications of the present invention without departing from the teachings and disclosure of the present invention can be made by those skilled in the art. Therefore, the protective scope of the present invention is not limited to the disclosure of the embodiments, but includes the variations and modifications without departing from the present invention, which is contemplated by the following claims.

1. A method for establishing a voice connection through a network, comprising:
receiving a voice information;
analyzing the voice information and generating a recognized result; and
establishing the voice connection through the network according to the recognized result.

2. The method of claim 1 further comprising:
providing a first default voice message when receiving a connection signal from an audio I/O device.

3. The method of claim 1, further comprising:
determining at least one IP or phone number corresponding to the voice information according to the recognized result.

4. The method of claim 1, wherein the voice connection is a single voice connection or a group of voice connection and is established by one of network telephony software comprising Skype, MSN, Google Talk, and VoIP software.

5. The method of claim 1 further comprising:
establishing a second voice connection through another IP or phone number when the voice connection through the network cannot be established.

6. The method of claim 5 further comprising:
establishing the second voice connection through another IP or phone number automatically or according to a user's selection.

7. A method for receiving a voice call through a network, comprising:
identifying the received voice call through the network and providing a voice information indicating the calling party;
getting through the voice call upon a user's command or providing a voice message asking the calling party to leave voice message according to the user's setting.

8. The method of claim 7 further comprising:
playing at least one left voice message upon the user's request.

9. A machine-readable medium embodied thereon a program configured to cause a machine to establish a voice connection through a network, the program comprising code segments for causing the machine to:
receive a voice information;
analyze the voice information and generate a recognized result; and
establish the voice connection through the network according to the recognized result.

10. The machine-readable medium of claim 9, the program further comprising code segments for causing the machine to:
identify a received voice call through the network and provide a voice information indicating the calling party;
get through the voice call upon a user's command or provide a voice message asking the calling party to leave voice message according to the user's setting.

11. The machine-readable medium of claim 9, the program further comprising code segments for causing the machine to:
provide a first default voice message when receiving a connection signal from an audio I/O device.

12. The machine-readable medium of claim 9, the program further comprising code segments for causing the machine to:
determine at least one IP or phone number corresponding to the voice information according to the recognized result.

13. The machine-readable medium of claim 9, the program further comprising code segments for causing the machine to:
establish the voice connection by one of network telephony software comprising Skype, MSN, Google Talk, and VoIP software.

14. The machine-readable medium of claim 9, the program further comprising code segments for causing the machine to:
establish a second voice connection through another IP or phone number when the voice connection through the network cannot be established.

15. The machine-readable medium of claim 9, the program further comprising code segments for causing the machine to:
establish the second voice connection through another IP or phone number automatically or according to a user's selection.

16. The machine-readable medium of claim 10, the program further comprising code segments for causing the machine to:
play at least one left voice message upon the user's request.

17. Apparatus for establishing a voice connection through a network, comprising:
a voice recognition unit for analyzing a received first voice information and generating a recognized result; and
a control unit, coupled to the voice recognition unit, for establishing the voice connection through the network according to the recognized result.

18. The apparatus of claim 17, further comprising a transceiving unit for receiving the first voice information from an audio I/O device and transmitting a second voice information from the control unit to the audio I/O device.

19. The apparatus of claim 17, further comprising at least one of network telephony software for establishing the voice connection, the network telephony software comprising Skype, MSN, Google Talk, and VoIP software.

20. The apparatus of claim 17, wherein the control unit establishes a second voice connection through another IP or phone number when the voice connection through the network cannot be established.
